(19) United States
(12) Patent Application Publication
(10) Pub. No.: US 2023/0150024 A1
(43) Pub. Date: May 18, 2023

(54) APPARATUS FOR MAKING FLAKES

(71) Applicant: LANDA LABS (2012) LTD, Rehovot (IL)

(72) Inventors: Benzion LANDA, Nes Ziona (IL); Guy FEFFERMAN, Givatayim (IL); Vadim YAKHEL, Kiryat Gat (IL); Yosef SHACHAK, Kfar Saba (IL); Viacheslav RABINOVICH, Ashkelon (IL); Aleksey Elisha LEVIN, Bnei Reem (IL)

(21) Appl. No.: 17/907,545

(22) PCT Filed: Apr. 1, 2021
(86) PCT No.: PCT/IB2021/052742

§ 371 Date: Sep. 28, 2022

(30) Foreign Application Priority Data
Apr. 2, 2020 (GB) 2004904.5

(51) Int. Cl. B22F 9/04; B22F 1/068

(52) U.S. Cl. CPC B22F 9/04; B22F 1/068; B22F 2301/052

(57) ABSTRACT

An apparatus is disclosed for producing flakes, the apparatus comprising:
a) a support structure for supporting each of two supply cylinders, made of a first material from which flakes are to be produced, and a fatiguing rod assembly including at least one fatiguing rod made of a second material, each fatiguing rod having a diameter smaller than an initial diameter of the two supply cylinders;
b) a compression mechanism for urging the surfaces of the two supply cylinders into contact with each fatiguing rod, and
c) a drive mechanism for causing the supply cylinders to rotate while making rolling line contact with each fatiguing rod.

The contact pressure between the supply cylinders and each fatiguing rod is set sufficiently high to modify the surface of the supply cylinders by fatigue and result in separation of flakes of the first material from the surfaces of the supply cylinders.

### CROSS-REFERENCE TO RELATED APPLICATIONS

The present application is a National Phase Application filed under 35 U.S.C. 371 as a national stage of International Application No. PCT/IB2021/052742, filed on Apr. 1, 2021, which claims Paris Convention priority from, GB 2004804.5, filed on 2 Apr. 2020. This application is also related to International Application No. PCT/IB2021/052743 titled “Method for Making Flakes”. The entire contents of the afore-mentioned applications are incorporated herein by reference for all purposes as if fully set forth herein. Any matter disclosed in GB 2004804.5, published as GB 2593768, but not contained in the present application is not disclaimed and the Applicant reserves the right to import matter disclosed therein into the present application.

### FIELD

The present disclosure relates to production of flakes, such as metal, ceramic, plastics or glass flakes.

### BACKGROUND

Particles having lamellar shapes are characterized by their aspect ratio, i.e. the ratio of a representative planar dimension to the transverse dimension, the greater the aspect ratio, the thinner the flake. The term “flake” is used herein to refer to a thin planar particle having an aspect ratio no less than 3:1 but usually significantly greater, for example between 10:1 and 100:1. Flakes are preferred in various fields, for example, metal flakes may be used in diverse industries such as painting, printing, coating, electrochemical electrodes, reflectors, fuel cell hydrogen storage devices, explosives, solar cells, and cosmetics. Aluminium flakes account for about 40% of the metal flakes that are currently produced, copper flakes forming about 24%, and zinc or stainless steel flakes each forming about 14% of this market, in which nickel flakes contribute approximately 8%. Because of the high demand for metal flakes, their production is a primary, though not sole, aim of the invention.

Metal flakes are conventionally made by hammering, ball milling, or physical vapour deposition (PVD). In the hammering method, a metal sheet is thinned by hammering and then reduced into flakes. Ball milling may be wet or dry and conducted at low or high speed. Examples of ball milling methods include attritor, vibratory, horizontal, and planetary ball milling. In any ball milling method, grinding media in the form of balls randomly collide with large metal particles that start as spheres or with a low aspect ratio. Due to the compression and shear forces that are exerted on the relatively large particles, they are progressively flattened into flakes. In physical vapor deposition, metal is vaporized and then deposited on a carrier. Once the metal has condensed into a film on the carrier, various techniques may be used to remove the film from the carrier in flake form.

Metal flakes prepared by hammering or ball milling tend to be relatively thick. Typically, they may have a thickness in the micron range (e.g., between 1 micrometer (µm) and 100 µm), with higher end products having a thickness in the sub-micron range (e.g., between 25 nanometer (nm) and 1 µm). By contrast, metal flakes prepared by PVD may be thinner, with a thickness in the range of 20 nm to 100 nm, flakes with a thickness in the range of 30 nm to 50 nm being generally preferred for visual effect in particularly demanding industries. Typically, the topography of the planar surfaces of PVD-prepared flakes is more regular than the topography of the planar surface of flakes prepared by ball milling. Therefore, PVD-prepared flakes are generally shinier than their non-PVD made counterparts, enabling the product in which they are used to display a higher gloss.

While PVD-prepared flakes are preferred for a number of industrial applications, their manufacturing method is more expensive, rendering their cost prohibitive for many products.

### OBJECT

The invention seeks therefore to provide inter alia a cost-effective method of producing flakes and an apparatus for doing the same.

### SUMMARY

According to a first aspect of the invention, there is provided an apparatus for producing flakes, comprising a support structure for supporting each of two supply cylinders, made of a first material from which flakes are to be produced, and a fatiguing rod assembly including at least one fatiguing rod made of a second material, each fatiguing rod having a diameter smaller than an initial diameter of the two supply cylinders, a compression mechanism for urging the surfaces of the two supply cylinders into contact with each fatiguing rod, and a drive mechanism for causing the supply cylinders to rotate while making rolling line contact with each fatiguing rod, wherein the contact pressure between the supply cylinders and each fatiguing rod is sufficiently high to modify the surface of the supply cylinders by fatigue and result in separation of flakes of the first material from the surfaces of the supply cylinders.

In some embodiments, the apparatus may further comprise a mechanism for supplying a fluid to each fatiguing rod and supply cylinder during rotation thereof, the fluid being operative to carry away flakes produced by the fatiguing of the supply cylinders, and a collector to collect the produced flakes and the fluid.

The apparatus may further comprise a separating system for separating at least a proportion of the flakes from the fluid. The separating system can eliminate the fluid (e.g., by drying) or isolate the flakes (or a proportion thereof), or both. A separating system for separating at least a proportion of the flakes from the fluid can be based on individual characteristics of the first material and relative affinity thereto (e.g., a magnet assisting in the separation of flakes made of a magnetic material) or rely on more universal properties (e.g., density, size, etc.) and proceed by decanting, centrifuging, or filtering.

The drive mechanism in some embodiments may comprise one or more motors connected to drive at least one of the supply cylinders, or a cylindrical surface in frictional contact with at least one of the supply cylinders. In some embodiments, each supply cylinder may be associated with a respective motor. The motors may be supported to accommodate relative movement between the axes of the supply cylinders associated therewith, as the outer diameters of the supply cylinders reduce during operation.

The speed of rotation of the supply cylinders and fatiguing rods may be such that the velocities of surfaces in contact with one other are matched. Alternatively, a relative velocity between contacting surfaces of the fatiguing rods and the supply cylinders, may be tolerated or even induced. A relative velocity of, for example, ± 10% can be provoked by applying a braking force to a rod or cylinder not connected to a drive motor, or in an arrangement comprising several motors, by operating the motors at different speeds.

According to a further aspect of the invention, there is provided a method of producing flakes, which comprises:
a. supporting two supply cylinders and a fatiguing rod assembly, that includes at least one fatiguing rod, in such a manner that each fatiguing rod is sandwiched between the two supply cylinders, each fatiguing rod having a diameter smaller than an initial diameter of the two supply cylinders and being made of a harder material;
b. urging the surfaces of the two supply cylinders into contact with each fatiguing rod; and
c. causing the supply cylinders and the fatiguing rods to rotate while making rolling line contact with one another;
wherein the supply cylinders and each fatiguing rod are urged against one another with sufficiently high contact pressure to modify the surface of the supply cylinders by fatigue and result in separation of flakes of the first material from the surfaces of the supply cylinders.

Additional objects features and advantages of the presently disclosed subject matter will be set forth in the detailed description which follows, and in part will be readily apparent to those skilled in the art from the description or recognized by practicing the presently disclosed subject matter as described in the written description and claims hereof, as well as the appended drawings. Various features and sub-combinations of embodiments of the presently disclosed subject matter may be employed without reference to other features and sub-combinations.

### BRIEF DESCRIPTION OF THE DRAWINGS

Some embodiments will now be described further, by way of example, with reference to the accompanying figures, where like reference numerals or characters indicate corresponding or like components and/or stages. The description, together with the figures, makes apparent to a person having ordinary skill in the art how some embodiments of the presently disclosed subject matter may be practiced. The figures are for the purpose of illustrative discussion and no attempt is made to show structural details of an embodiment in more detail than is necessary for a fundamental understanding of the presently disclosed subject matter. For the sake of clarity and convenience of presentation, some objects depicted in the figures are not necessarily shown to scale.

In the Figures:

FIG. 1 is a schematic diagram of a flake fabrication apparatus in accordance with some embodiments of the invention;

FIG. 2 is a diagram showing an alternative embodiment in which the fatiguing rod assembly having a single rod in FIG. 1 is replaced by one having two rods;

FIG. 3 is a schematic section through a flake fabrication apparatus in accordance with the invention;

FIG. 4 shows a detail of the apparatus of FIG. 3 drawn to an enlarged scale;

FIG. 5 is a perspective view of an apparatus of the invention having multiple supply cylinders;

FIGS. 6 and 7 show plan views of the supply cylinders of a flake fabrication apparatus at the commencement and completion of operation, respectively;

FIG. 8A shows how patterning may be applied to the surface of fatiguing rods in an embodiment of the invention;

FIG. 8B shows an alternative cross section of the exemplary helical groove in FIG. 8A; and

FIGS. 9A, 9B and 9C show three possible constructions of the supply cylinders.

### DETAILED DESCRIPTION

### Overview

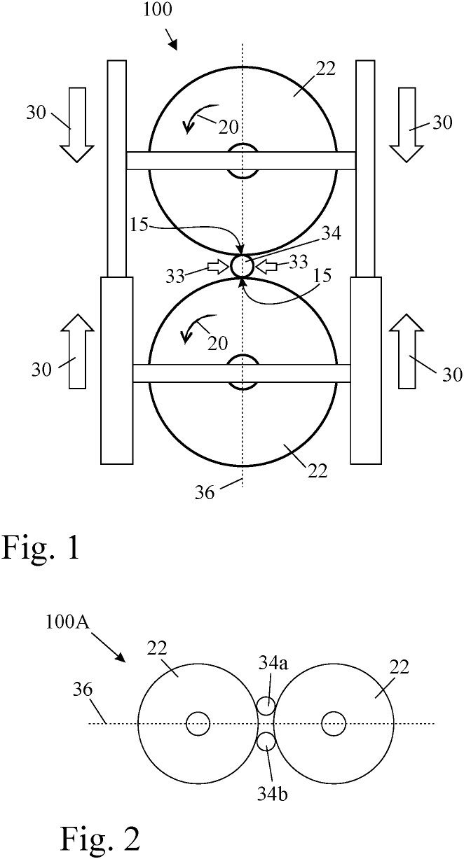

FIG. 1 is a schematic diagram of part of an apparatus 100 illustrating the method used in the present disclosure for the production of flakes. The apparatus 100 comprises two supply cylinders 22 made of the material from which flakes are to be produced and a fatiguing rod assembly, comprising a single fatiguing rod 34, sandwiched between them. The material to be flaked of the supply cylinders can also be referred to as a “first material”, whereas the material forming the fatiguing rod can also be termed a “second material”. A support structure, represented schematically by arrows 30 and 33, holds the supply cylinders 22 with their axes parallel to one another and the fatiguing rod 34 with its axis in the same plane as the axes of the two supply cylinders 22, the plane being represented in the drawing by a dotted line 36. While supported in this manner, the supply cylinders 22 are urged towards one another, as represented by arrows 30 in the drawing, to compress the fatiguing rod 34 between them and they are rotated at the same time in the directions indicated by arrows 20, so that rolling contact is made at the contact areas, designated 15 in the drawing, and also herein termed the nip, between each supply cylinder 22 and the fatiguing rod 34.

Because of the small diameter of the fatiguing rod 34, a high force is applied to the supply cylinders 22 over a small contact area 15, and the resulting pressure is sufficient to disturb and weaken the crystal structure of the first material at the surface of the supply cylinders 22. The repeated application and removal of this pressure as the supply cylinders 22 rotate results in their surfaces being fatigued and flaked.

To avoid the surface of the fatiguing rod 34 flaking at the same time, it should be made of a second material harder than the first material. For example, when the supply cylinders 22 are made of a metal (e.g., aluminium, copper, nickel, stainless steel, zinc, etc.), the fatiguing rod 34 may be made of a ceramic material (e.g., tungsten carbide) or of a harder same or different metal (e.g., stainless steel).

Instead of the fatiguing rod assembly comprising a single rod 34 lying with its axis in a plane containing the axes of the supply cylinders, it may, as shown in the apparatus 100A of FIG. 2, comprise two rods 34a and 34b disposed, respectively, above and below the plane 36 of the axes of the supply cylinders 22. In both embodiments, the support structure must ensure that each fatiguing rod does not move in the plane perpendicular to the plane of the axes of the supply cylinders 22. The embodiments described below are shown with a fatiguing assembly having a single rod, but it should be understood they may all alternatively employ assemblies with two fatiguing rods.

The remainder of the apparatus 100 is required to perform the following functions:
I. The apparatus should include a support structure, as mentioned above, to support the supply cylinders 22 in such a manner as to permit them to rotate, while allowing their axes to move towards one another.
II. The support structure should support the fatiguing rod(s) 34, while preventing them from moving in a plane perpendicular to the plane 36.
III. The apparatus should include a mechanism for urging the supply cylinders 22 towards, one another. And
IV. The apparatus should include one or more drive motors for rotating at least one of the supply cylinders and/or the fatiguing rods.

Aside from the above, as the apparatus is intended for commercial production of flakes, a system is required to collect the flakes generated during operation by fatiguing of the surfaces of the supply cylinders. Such collection can take place before and/or after a separation of at least a proportion of the produced flakes from the fluid.

While in FIG. 1 the supply cylinders 22 are urged towards one another, compressing therebetween the fatiguing rod 34, by forces simultaneously applied in opposite directions, parallel to arrows 30 in the drawing, this is not necessarily the case. A force can be applied in a single direction (e.g., upward or downward in the drawing), optionally urging the supply cylinders and the fatiguing rod assembly sandwiched therebetween against a support surface. In such a case, and assuming the support surface is a support cylinder, a drive motor can alternatively be used to rotate the support cylinder, instead of a supply cylinder or a fatiguing rod.

The sets of supply cylinders and supply rod assemblies schematically illustrated in FIGS. 1 and 2 can serve as “elementary units” being “repeated” in larger apparatuses, as shall be later detailed with respect to an embodiment wherein a plurality of supply cylinders has the respective axis of rotation of the cylinders lying in a same plane, a fatiguing rod assembly (comprising one or two rods) being disposed between any two supply cylinders facing one another.

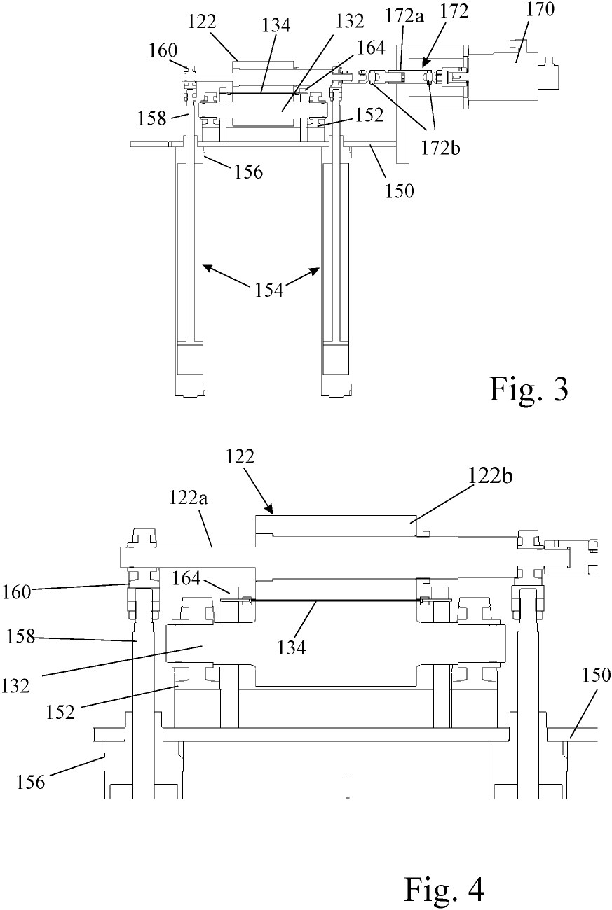

FIGS. 3 and 4 show a basic embodiment of an apparatus that fulfils the requirements as set forth above for schematic apparatus 100. The apparatus in this embodiment includes only two supply cylinders 122, 132 and a single fatiguing rod 134 disposed between them. FIG. 4 shows more clearly alternative possible designs of the supply cylinders. The cylinder 122 is shown as comprising a central shaft 122a carrying an outer sleeve 122b. In such a construction, the central shaft 122a may be made from a different material (e.g., harder) from the surrounding sleeve 122b, which may for example be a shrink fit on the shaft 122a. The cylinder 132 on the other hand is made entirely from the material from which flakes are to be produced.

The support structure in this embodiment comprises an end plate 150 on which are mounted two pillow blocks 152. The supply cylinders 132 is journaled in bearings in the pillow blocks 152. Two hydraulic rams 154 have cylinders 156 connected to the opposite side of the end plate 150 from the pillow blocks 152 and piston rods 158 passing through the end plate 150. The supply cylinder 122 is journaled in pillow blocks 160 connected to the ends of the piston rods 158. The fatiguing rod 134 is located between the two supply cylinders 122, 132 and its ends are slidably received in guides 164 that prevent it from moving out of the plane of the drawing while allowing it to rotate and to translate in the plane of the drawing.

A motor 170 is connected to the supply cylinder 122 by means of a coupling 172. As the motor is stationarily mounted, the coupling 172 needs to allow relative movement between the supply shaft and the motor 170. Thus, the coupling may comprise a variable length shaft 172a, comprising splined telescoped sections, with universal joints 172b at the opposite ends of the shaft 172a. It would alternatively be possible for the motor to be mounted movably, to follow the movement of the supply cylinder to which it is connected.

The apparatus of FIGS. 3 and 4 meets all the requirements indicated above in that it allows the supply cylinders 122, 132 to rotate and to move towards one another while hydraulically applying a force to the ends of the supply cylinders to urge them against one another. The motor 170 serves to rotate the supply cylinder 122, which in turn drives the supply cylinder 132 and the fatiguing rod 134, while the latter is trapped between the supply cylinders 122, 132 by the guides 164.

As explained previously, as the supply cylinders 122, 132 are turned by the motor 170 and are pressed against the harder fatiguing rod 134, with repeated cycling, the surfaces of the supply cylinders 122, 132 are fatigued and the resultant modifications cause flakes to break away from the surfaces.

To collect the produced flakes a fluid, preferably a liquid, is applied at least to the nip(s) between the supply cylinders 122, 132, and any intermediate fatiguing rod, as they rotate. The fluid can be passed through a filter to separate the desired flakes and may be recycled after filtration. The filtration may either remove all the particulate matter from the liquid before it is recycled, or it may be designed to allow a proportion of the flakes carried by the fluid to be recycled to the nip(s).

Aside from serving as a means of collecting the produced flakes, the liquid may serve for other purposes, such as lubrication and cooling.

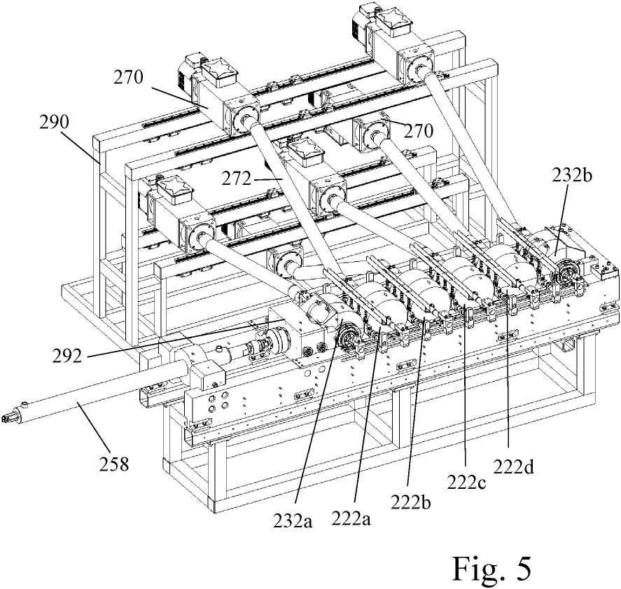

An apparatus more suited to commercial production but operating on the same principles as described above is shown in FIG. 5. In this case, the drawing also shows the support structure for the supply cylinders, the fatiguing rods, and the drive motors.

The primary difference between the apparatus of FIG. 5 and that of FIGS. 3 and 4 is that it comprises a bank of four supply cylinders, designated 222a to 222d. In this embodiment, the cylinders in the bank are arranged horizontally side by side, rather than vertically one above the other, but the orientation is immaterial. There are however further differences which may be incorporated in an embodiment with only two supply cylinders. One such difference is that, whereas in FIGS. 3 and 4 only one motor is provided for two supply cylinders, FIG. 5 shows that it is possible for each supply cylinder 222a - 222d to be driven by a respective motor 270 through a respective coupling 272. This, however, is not essential, and it may still be possible to drive a plurality of supply cylinders and attritions rods with a single motor or with a number of motors being less that the total number of cylinders and rods that may be driven thereby.

In still further embodiments, not illustrated, motors may additionally of alternatively be connected to drive the fatiguing rods.

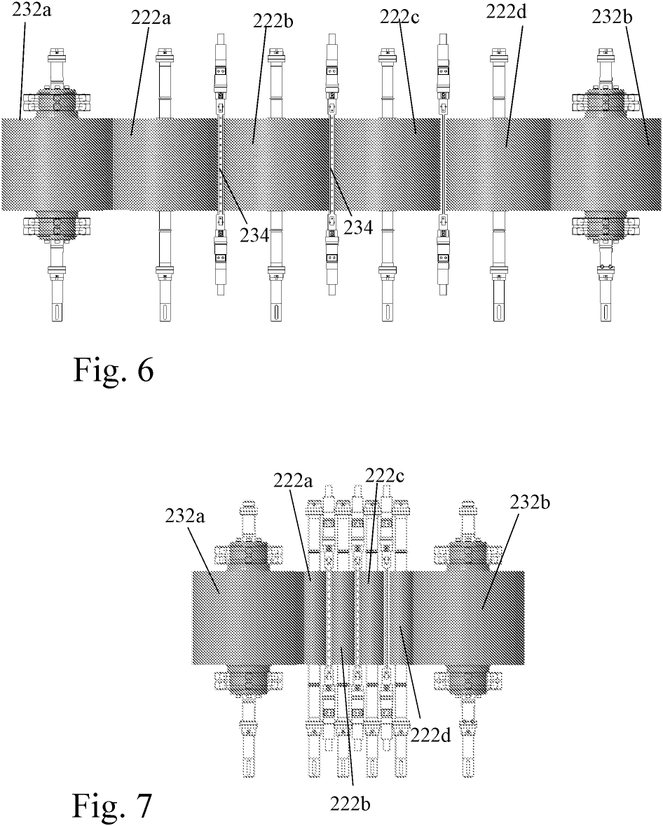

The supply cylinders 222a - 222d, the fatiguing rods 234 (that are trapped between the supply cylinders as more clearly shown in FIGS. 6 and 7), and the motors 270 are all slidably mounted on a support structure 290, which is constructed as a framework made up of box section metal bars that can be welded or otherwise attached to one another. Because the exemplary motors 270 illustrated in FIG. 5 are larger than the supply cylinders 222a - 222d, in particular when considering the final diameters, they may each reach following flaking, they need to be mounted further apart than the cylinders. This can be achieved, as shown in the drawing, by the motors being supported at different levels. The motors can be slidably mounted on the support structure 290, to move with the supply cylinders as their diameters are reduced, If the motors 270 in FIG. 5 were, on the contrary, stationary, their couplings 272 would need to include extendable shafts, as earlier described.

The support structure 290 also includes guides arranged on opposite sides of the bank of supply cylinders 222a - 222d. Blocks within which the axial ends of the supply cylinders, and of the fatiguing rods, are journaled are freely slidable along the guides. Instead of acting on the axial ends of the supply cylinders, the piston rod 258 of a hydraulic ram in this embodiment is used to compress the entire bank of supply cylinders 222a - 222d between two support cylinders 232a and 232b that act upon the end supply cylinders 222a and 222d of the bank. As shown in FIG. 5, the support cylinders 232a and 232b may also be connected to respective drive motors 270 and these may be in addition to, or instead of, the motors connected to the supply cylinders 222a - 222d. Driving only one, or both, of the support cylinders 232a, 232b, considerably simplifies replacement of the supply cylinders of the bank once they have reached their minimum diameter and it avoids the need to provide drive couplings on the supply cylinders.

The support cylinder 232a is supported by bearings in a carriage 292 that is slidable relative to the guides of the supply cylinders 222a - 222d under the action of the piston rod 258. The second support cylinder 232b is mounted in a similar carriage that is anchored to the support structure 290. While the support structure of inter alia the motors and of inter alia the supply cylinders is commonly referred to as support structure 290, they need not be part of a same integral structure and can be constituted of two separate structures. Having separate supporting structures may facilitate installation and maintenance.

FIG. 6 shows a plan view of the bank of supply cylinders 222a - 222d of FIG. 5 at the commencement of operation and FIG. 7 is a similar view after the material of the supply cylinders has been significantly consumed. The supply cylinders are deemed exhausted when reaching a minimum diameter, such as the diameter of a central shaft. It will be seen from these figures that the support cylinders 232 are not reduced in diameter during the production of flakes.

In FIGS. 6 and 7, it will be seen that there is no fatiguing rod between the end supply cylinders 222a and 222d and the adjacent support cylinders 232a and 232b. In this case, the intermediate supply cylinders 222b and 222c will be depleted more quickly than the end supply cylinders 222a and 222d, because each is in contact with two fatiguing rods (or two rod assemblies, each having two rods) rather than only one. As readily appreciated, it is possible to change the relative position of the supply cylinders in the bank of cylinders, to ensure they are similarly consumed before one of them is exhausted. It would be alternatively possible, to provide fatiguing rods between the end supply cylinders and the support cylinders but care must be taken in choosing the material to ensure that the surface of the support cylinders 232a, 232b is not caused to flake at the same time. If, for example, the supply cylinders are of aluminium (Al), then the fatiguing rods may be of tungsten carbide and the support cylinders of stainless steel.

It is stressed that while these drawings illustrate that the bank of supply cylinders may be maintained between support cylinders at both ends, such an assembly need not be construed as limiting. A bank of supply cylinders may be supported at only one of its ends or may be devoid of support cylinders. Pressure can be applied to the axials ends of a supply cylinder or of a fatiguing assembly, and the bank of supply cylinders may be “terminated” at each of its ends by a supply cylinder 222 or a fatiguing rod 234 (or an assembly of a pair of rods). In such cases, when a support cylinder is absent from an end of the bank, the axes of the terminal element (e.g., supply cylinder 222 or fatiguing rod 234) should be maintained so that the terminal element can additionally serve as support for the other elements (e.g., supply cylinders) of the bank being urged against it, the terminal element not contacting any surface other than surfaces of the bank’s elements. If for instance, the terminal element is a fatiguing rod assembly, the assembly need be maintained so as to only contact a supply cylinder on one side and nothing on the diametrically opposite side.

Having provided an overview above of the apparatus of the present disclosure, the different components of the apparatus will now be considered individually.

### Supply Cylinders

The supply cylinders (such as 22, 122, 132, or 222 in the illustrated non-limiting embodiments) may be made of any material that is to be flaked, such as a metal, a ceramic, a plastic or a glass material. As used herein, the term metal may refer to a pure metal, an alloy, a metalloid, a composite, or any other combination that includes one or more metallic elements. Flakes made of any such metals can be referred to as metal flakes or metallic flakes.

In some embodiments, the supply cylinders may include a material that comprises primarily a metal selected from the group comprising aluminium, brass, bronze, copper, gold, graphite, lithium, nickel, silver, stainless steel, steel, tin, and zinc; or a ceramic selected from the group comprising alumina, calcite, glass (e.g., borosilicate), quartz, obsidian and talc. In some particular embodiments, the supply cylinder may include a material that comprises primarily aluminium (e.g., Al 1050, Al 1100, Al 1199, another member of the aluminium 1xxx series where x represents any valid digit, Al 2024, Al 6061, Al 7075, Al A356, Al A4047 or Al RSP), or that comprises primarily stainless steel (e.g., stainless steel 17-4 PH®, stainless steel 304, or stainless steel 303). In further embodiments, the supply cylinder may be made of plastic materials (e.g., thermoplastic polymers such as poly(methyl methacrylate (PMMA) and polyether ether ketone (PEEK)) or of ceramic materials (e.g., quartz). Herein, reference to a material comprising primarily a component, means that the component constitutes a major portion of the material, which can be less than 50% by weight of the composition of the material for alloys, co-polymers or composite materials, but is typically at least 50 wt.%, such as at least 55 wt.%, at least 60 wt.%, at least 75 wt.%, at least 80 wt.%, at least 90 wt.%, at least 95 wt.%, at least 99 wt.% or 100 wt.% of the composition of the material.

As illustrated in FIG. 9A, each supply cylinder may integrally incorporate an axle extending laterally out of the body of the cylinder being flaked (see also the supply cylinder 132 in FIG. 4), the lateral extensions being supported by the structure of the apparatus. A supply cylinder may alternatively be constituted of a support shaft and a supply sleeve (as shown by the supply cylinder 122 in FIG. 4 and FIG. 9B). In a further alternative, shown in FIG. 9C, the supply cylinder can be constituted of a cylinder having a central recess in its end faces, the recess serving to maintain the cylinder between a pair of tailstocks, each slidably mounted on a side of the support structure.

### Fatiguing Rods

Depending on the material of the supply cylinders, each fatiguing rod (such as 34, 34a, 34b, 134 or 234 in the illustrated non limiting embodiments) may be made from a second material harder than the first material of the supply cylinders.

When a fatiguing assembly includes two fatiguing rods, they need not be identical. For instance, while one of the fatiguing rods may be made of a second material, the other fatiguing rod may be made of a different material. Alternatively, or additionally, the outer surfaces of each fatiguing rod of the assembly may also differ; same or different second materials and/or same or different textures of each of the fatiguing rods being as further detailed herein.

It is noted that while two different fatiguing rods may be found in a same rod assembly, for instance one rod 34a being relatively polished and the other rod 34b being relatively more textured (e.g., having a rougher outer surface or being patterned), differences between fatiguing rods may be similarly implemented with rod assemblies constituted of a single rod. Considering for illustration, supply cylinder 222b of FIG. 6 which shows a plan view of a bank of supply cylinders, rod 234 on its left side can be different from rod 234 on its right side (e.g., being made of different materials and/or having different textures on their outer surfaces).

Similar principle of having different fatiguing rods on diametrically opposite sides of a same supply cylinder can also be realized with rod assemblies of two rods, in which case the different rods need not be in the same assembly on a same side but can be in the two rod assemblies separated by the supply cylinder. Thus, regardless of the manner elected, in some embodiments of the present apparatus, a same supply cylinder can be contacted by at least two fatiguing rods, at least one of the fatiguing rods differing from the other(s). In a particular embodiment, the difference between the differing rods includes the texture of their outer surface, one of the rods being relatively smooth. The differing rods may additionally differ by any other feature of the rods, such as the materials they are made of, their diameters, or any other treatment affecting their properties.

The fatiguing rod can comprise primarily a metal or a ceramic selected from the group comprising aluminium (Al), aluminium nitride (AIN), alumina (Al₂O₃), boron carbide (B₄C), boron nitride (BN), cubic boron nitride (CBN), chromium carbide (Cr₃C₂), diamond, sapphire, silicon carbide (SiC), silicon nitride (Si₃N₄), stainless steel, steel, tantalum carbide (TaC), titanium carbide (TiC), titanium nitride (TiN), tungsten carbide (WC), and zirconia (ZrO2). A fatiguing rod may be further coated, typically by a different and harder compound. For example, a fatiguing rod can be primarily made of tungsten carbide with a film coating including titanium (e.g., aluminium-titanium-nitride (AlTiN) and aluminium-titanium-silicon-carbon (AlTiSiC)). To the extent that a fatiguing rod is made of a material of a chemical family similar to the supply cylinder, the material making up of the rod (or a coating thereof) need be harder than the material making up the supply cylinder. For example, a supply cylinder made of aluminium alloy Al 1050, having a Vickers Hardness number of about 30 HV, can be flaked in an apparatus according to the present teachings by a fatiguing rod made of Al 7075, an aluminium alloy having a hardness of about 175 HV.

In some particular embodiments, a fatiguing rod (e.g., 34, 134, or 234, being present in the fatiguing assembly as a unique rod or as a pair of rods) may comprise primarily tungsten carbide (e.g., also including cobalt which serves as a binder), stainless steel, silicon carbide, or be made of tungsten carbide with a titanium coating (e.g., TiAIN).

In some embodiments, the fatiguing rod is made up of a second material whose hardness is significantly larger than the hardness of the first material which makes up supply cylinders, e.g., at least 5 times, at least 10 times, at least 20 times, at least 50 times, or at least 100 times harder. For example, a fatiguing rod may comprise primarily tungsten carbide while the supply cylinders may comprise primarily aluminium or stainless steel. Taking for illustration cylinders made of tungsten carbide (WC) having a hardness of about 2600 HV, stainless steel (SST) having a hardness of about 240 HV (in a typical range of 140-350 HV) and one aluminium alloy having a hardness of 40 HV (in a typical range of 20 HV to 180 HV), then the ratio between hardness of the fatiguing rod and hardness of the supply cylinder would be about 11 for WC/SST, and about 65 for WC/A1.

Ultimately the hardness ratio depends on a) the exact composition of each cylinder and rod, and b) whether the bulk material was further treated (e.g., annealed, cold worked, hardened, heat treated or tempered), and in the affirmative to what extent (e.g., stainless steel can be tempered to be 1/16, ⅛, ¼, ½, ¾, or Full Hard), different grades being more suitable if the material is to be used for a support cylinder (relatively harder/less ductile grades being preferred), or for a supply cylinder (relatively less hard/more ductile grades being also suitable). Moreover, hardness of the cylinders outer surfaces may be modified by the process and operating conditions of the apparatus. While the relative properties of supply cylinders and fatiguing rods are provided above with respect to their hardness, a person skilled in materials and their physical properties can readily “translate” such requirements in other terms, such as strength, yield point and the like. The yield point of the fatiguing rod should be sufficient to avoid or minimize deformation and/or wear of the rod surface under the operational conditions of the apparatus and being greater than the yield point of the material of the supply cylinders.

Another important advantage of using ceramic fatiguing rods is that their Young’s module is much higher than metals, so they bend less under the applied force. When the rods are bent the pressure distribution at the nip is not uniform and using ceramic fatiguing rods allows building of wider machines for the same degree of rod deflection.

It has been found that the surface finish of the fatiguing rods has a significant effect on both the quality of the flakes produced (e.g., including their dimensions) and their rate of production. While the fatiguing rods may be polished to a mirror finish (e.g., having a mean surface roughness (Ra) of 50 nm or less, or even 20 nm or less), in alternative embodiments they may be textured. Such textures can be achieved by an increased roughness of the surface of the rods (e.g., having a Ra of 100 nm or more), as may result from the manufacturing process of the rod in absence of a smoothening step typically otherwise included. Roughness can be measured by routine methods using a profilometer suited to the surface topography. Ra can for instance be measured using a contact stylus profilometer or using a non-contact optical profilometer. In some embodiments, the roughness of the fatiguing rod (or of any other surface) shall be measured using a confocal laser microscope (LEXT OLS5000 3D of Olympus Corporation) at a magnification of x50.

Textures can be deliberately formed by chemically etching or physically scratching the rod surface (e.g., with diamond polishing pads of desired grit) or by coating the rod surface, typically with a third material which differs from the second material of which the rod is made. The coating can be with a continuous layer of material or with discrete particles, the size of the particles contributing to the perceived resulting roughness of coat formed thereby. For instance, fatiguing rods can be coated with diamond powders incorporated during electroless nickel plating of a stainless steel rod. A wide range of roughness levels can be achieved by such methods, the Applicant having prepared rods having a roughness Ra of about 20 nm, 100 nm, 200 nm, 250 nm, 400 nm, 500 nm, 700 nm, 800 nm, 1,600 nm, 2,000 nm and 5,000 nm, and having observed a positive correlation between the roughness of the fatiguing rods and the rate flakes could be produced therewith. Without wishing to be bound by any particular theory, it is assumed that an increased roughness of the fatiguing rods may improve their contact efficiency with the surface of the supply cylinders, thus facilitating their fatiguing. As appreciated, fatiguing rods can be similarly prepared to achieve any intermediate value of surface roughness, including values above standard roughness of unpolished parts (e.g., 1,000 nm, 1,200 nm, 1,400 nm, 1,800 nm, 2,500 nm, 3,000 nm, 3,500 nm, 4,000 nm, 4,500 nm, and so on) or any greater value (e.g., 10 µm, 25 µm, 50 µm).

While the above exemplary methods result in relatively random jaggedness on the surface of the textured fatiguing rods, the rods may additionally or alternatively be patterned in a more regular manner. For instance, a pattern may be formed in the surface of fatiguing rods by machining or laser cutting, or any other patterning method adapted to the material forming the rod. The pattern, in some embodiments, may be a series of annular grooves or a continuous helical groove. In such embodiments, it has been found that such parameters as the width of the groove, its pitch and its depth all affect have effect on the flake production and their value can be determined empirically based on desired flake size and flake production rate. The pattern can be considered as a “negative” pattern of grooves in the surface at the outer diameter of the fatiguing rod surface, or as a “positive” pattern of protrusions projecting from the inner diameter of the fatiguing rod (e.g., from the surface comprising the lowest portion of the grooves).

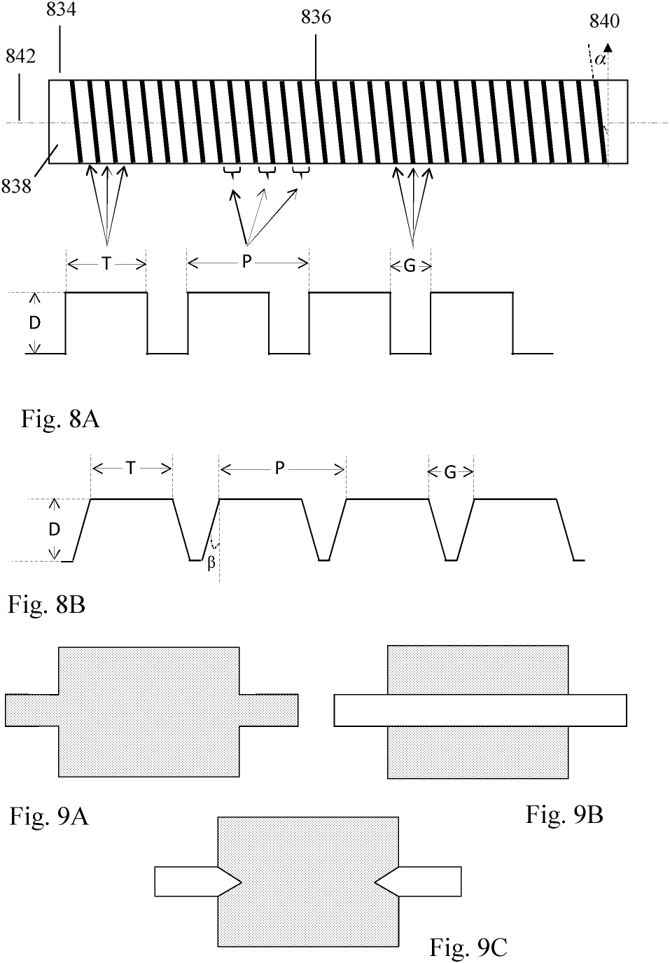

FIG. 8A shows a fatiguing rod 834 having an axis 842 and a single helical groove 836 defining raised or protruding regions 838. The helical angle α is the angle between turns of the groove and the plane 840 that is normal to the axis 842. The lower part of FIG. 8A shows to enlarged scale a section through the groove 836 to identify the different parameters of the groove 836. The width of the groove is designated G, the width of raised regions between turns of the groove is designated T, the depth of the groove is designated D. The pitch P of the groove is equal to the sum of T and G. In FIG. 8A, the groove is shown as having sides lying in a plane normal to the axis 842 but, as shown in FIG. 8B, it is alternatively possible for the sides to be inclined at an angle β.

A wide range of patterns can be formed on the surface of the fatiguing rod, the Applicant having prepared rods wherein the gap width G was selected from 50 µm, 60 µm, 150 µm, 160 µm, 200 µm, 230 µm, and 280 µm, the top width T was selected from 25 µm, 50 µm, 130 µm, 160 µm, 200 µm, 240 µm, and 360 µm, the groove depth D was selected from 10 µm, 35 µm, 90 µm, 160 µm, 170 µm, 190 µm, and 400 µm, and the angle α was selected from 0°, for annular grooves, and 2°, 30°, and 40°, for helical grooves. Patterns having annular grooves and helical grooves were prepared by laser cutting for the relatively thinner grooves tested on fatiguing rods made of ceramic (e.g., tungsten carbide) and by machining for the relatively larger grooves tested on fatiguing rods made of metal (e.g., stainless steel). As appreciated, fatiguing rods can be similarly patterned with parameters having any other value, including but not necessarily intermediate values.

For instance, the width of a groove G (or the distance between lateral edges of adjacent protrusions or adjacent projections) can be between 25 µm and 300 µm, or between 25 µm and 250 µm, or between 25 µm and 200 µm; the width of top surface T between two grooves can be of at least 25 µm, at least 50 µm, at least 100 µm, or at least 200 µm; and optionally at most 500 µm, at most 400 µm, or at most 300 µm; the depth D of a groove (or the height of the protrusion or projection) can be of at least 3 µm, at least 50 µm, or at least 100 µm; and optionally at most 300 µm, at most 250 µm, or at most at most 200 µm; the angle by which a grove can be tilted with respect to the direction of rotation can be any value up to ± 90°, and optionally between 0° and 60°, between 2° and 50°, or between 5° and 45°, the angle being tilted either to the right or to the left.

While FIG. 8A illustrates a single helical groove tilted to the left side of the drawing, other patterning of the fatiguing rods is possible. For example, two oppositely handed helical grooves can result in a diamond pattern on the surface of the rods, if both are designed to extend along the entire length of the rod. Alternatively, a segment of the fatiguing rod can include grooves tilted in one direction and another segment can include grooves tilted in an opposite direction. For example, half of the rod may have right-handed helical grooves and half of the rod left-handed helical grooves.

The pattern may even be random and produced by roughening the surface of the rods. In this case, chemical etching may be used as an alternative to laser cutting. The roughness may either be integral to the material of the rod or may result from a coating of the rod. If a coating is employed for providing a desired roughness to a patterned rod, the coating may be applied before or after the patterning. For illustration, a fatiguing rod can be patterned to display a helical groove and subsequently further coated with diamond particles, the size of the particles being selected in accordance with the parameters of the pattern. When a fatiguing rod displays both a pattern and a roughness, the roughness is typically measured on the top of the protrusion, on the surface between the grooves which is characterized by a width T.

In some embodiments, the diameter of the fatiguing rods (e.g., 34, 134, 234, or 834) may be small compared to the initial diameter of the supply cylinders (e.g., 22, 122, 132, or 222). The diameter of the fatiguing rods is relatively smaller when constituting not more than 5%, not more than 10%, not more than 15%, not more than 20%, or not more than 25% of the diameter of supply cylinder. The small diameter of the rods allows a greater pressure to be applied at the nip for a given compression force. The diameter of the fatiguing rod can also be adapted to a particular bank of supply cylinders. For instance, if a support cylinder is absent from a terminal position in an assembly of cylinders and a fatiguing rod is to serve as ultimate rolling surface, its diameter should preferably be on the larger end of the relative scale, to ease maintaining its axes of rotation stationary with respect to the force being applied to urge the cylinders in contact.

As other cylinders of an apparatus according to the present teachings, a fatiguing rod can be journaled in a pair of bearings slidably mounted in the support structure. Any other arrangement allowing the rods to rotate, in particular when in contact with the supply cylinders, can be suitable. Such arrangements are generally configured to substantially prevent lateral displacement of the cylinders in a direction along their axes of rotation, only enabling rotation within the frame of the supporting structure in a direction essentially parallel to the force urging the supply cylinders and the rods into rolling contact. The direction the force is applied to urge the supply cylinders and the fatiguing rods together can be referred to as the X-direction and the traverse direction of their axes of rotation can be referred to as the Y-direction. The clockwise or counter-clockwise rotation of the cylinders lead to a relative displacement of their axes of rotation in the X-direction, as material is flaked and the diameter of the supply cylinders is reduced. As mentioned, there is some tolerance in the Y-direction, and for example assuming a point of reference on a cylinder, this point may be within ± 250 µm of its expected location in absence of displacement in this direction. Taking FIG. 6 for illustration, supply cylinders 222, support cylinders 232 and fatiguing rods 234 may rotate about an axis parallel to the Y-direction and move to the left or the right in the X-direction as their diameters decrease, but typically they would not be significantly displaced (e.g., by more than 250 µm) in the Y-direction, i.e. upward or downward as viewed in the drawing.

However, in some embodiments, some lateral displacement may not only be tolerated, but desirable and enabled. In such cases, in view of their smaller size, it is more convenient, though not essential, for the elements that are permitted to have their axes of rotation displaced in the Y-direction while rotating to be the fatiguing rods. Taking again FIG. 6 for illustration, and a point of reference on a fatiguing rod 234, this point would draw a sinusoid curve as the rotation of the rod and the flaking of the supply cylinders close the distance in a left to right X-direction and as the oscillation of the rod by lateral displacement along a Y-direction shifts this point up and down, in this particular view. The fatiguing rods can accordingly be referred to as oscillating between the opposite sides of the supporting structure. Usually, the peak amplitude of the oscillation, how far away the point of reference can distance itself from an ideally locked position, can be of more than 500 µm, being of 1 mm or more, 1.5 mm or more, 2 mm or more, or 2.5 mm or more.

The effect of the oscillation is inter alia to increase the production rate, if desired. To the extent that a regularly patterned rod may form repeated striations on the surface of the supply cylinder, and that such formation adversely affects the production rate of the flakes, an optimum peak amplitude of oscillation of the fatiguing rod (or a range of suitable amplitudes) can be selected to exceed the distance between the repeated striations that might otherwise have formed on the supply cylinder. The amplitude of oscillation of a fatiguing rod would depend on the nature of the patterning of the surface of the fatiguing rods and be selected so as to maintain a more even (e.g., non-patterned) surface of the supply cylinders for a longer period of time. Alternatively, or additionally, repetitive striations on the supply cylinders can be avoided, or diminished if present, by relying on a fatiguing rod lacking a regular pattern, the rod being either relatively smooth or randomly textured (e.g., rough).

### Support Cylinders

To the extent that a support cylinder is included in an apparatus according to the present teachings, it can be selected in accordance with the supply cylinders and fatiguing rods, its properties typically being intermediate to both. For instance, a support cylinder can be made of a fourth material, the fourth material being generally harder than the first material of the supply cylinders, but less hard than the second material of the fatiguing rod, or of a third material coating it. As previously explained, while the relative properties are illustrated above in terms of hardness, a skilled person may alternatively elect suitable combinations of materials in other terms (e.g., Young’s modulus, yield point, etc.). As fatiguing rods, the supply cylinders should be selected and adapted to avoid or minimize deformation and/or wear of their surface under the operational conditions of the apparatus. The support cylinders can accordingly be made of any of the materials previously exemplified, if satisfying the aforesaid. Their diameter is generally larger than the diameter of the fatiguing rods, and optionally, but not necessarily, larger than the initial diameter of the supply cylinders. The support cylinders can be supported by the structure of the apparatus in any of the different ways shown in FIGS. 9A to 9C for the supply cylinders.

### Compression Mechanism

In the illustrated and described embodiments, a force is applied to compress the fatiguing rods (e.g., 34, 134, 234, or 834) of the respective assemblies of rods between the supply cylinders (e.g., 22, 122, 132, or 222) by means of a hydraulic ram. In alternative embodiments, a force may be applied pneumatically or by means of an electric motor. A weight can alternatively be used to create compression based on gravitational force applied via a suitable arrangement. A lever system or a gear mechanism may if necessary be employed between the motor and bank of supply cylinders. If a hydraulic system is employed, it may include an accumulator to provide damping of pressure fluctuations.

The pressure at the nip affects the rate at which flakes can be produced and their quality. If too little pressure is applied, then the flake production rate will be low. On the other hand, if too much pressure is applied then non-flake fragments and/or undesirably thick flakes may be removed from the supply cylinders. The optimum pressure is dependent inter alia on the yield strength (also referred to as yield point) and/or tensile strength of the material of the supply cylinders. It is possible to determine empirically an optimal pressure to minimize the amount of energy required to produce a given mass of flakes, in order to minimize production costs.

While compression is typically applied in one direction (e.g., from one end of a bank of supply cylinders to the other end of the bank), it may alternatively be concomitantly applied in opposite directions. In such a case, a support cylinder may optionally be inserted in a bank of supply cylinders at a position corresponding to the “terminus” of the opposite forces of compression. For illustration, assuming a bank of four supply cylinders, the supply cylinders, their fatiguing rods, and the opposite compressions forces from each end being respectively similar, a support cylinder may be included in the middle of the bank, between two pairs of supply cylinders.

Conceivably, while the illustrated embodiments present a compression being applied in one or two directions along a single line (e.g., the axes of the supply cylinders lying in a single plane), supply cylinders may be arranged radially with respect to a core cylinder (e.g., being one of the supply cylinders of the bank or being a support cylinder). In such a case, compression would be applied radially inwardly towards the core of the arrangement.

### Collection of Produced Flakes

As earlier mentioned, a fluid can be used during operation of the apparatus, as illustrated by apparatus 100, the fluid being applied at least at nip(s) 15. The fluid may, for instance, provide lubrication at nip 15 and/or elsewhere in apparatus 100. The fluid, which may cause a limited degree of slip, can also serve for temperature control.

The fluid can assist in flake removal e.g., by gently washing off the flakes from the surface of the supply cylinders and transporting such removed flakes away from supply cylinders, or by more forcefully removing the flakes from the supply cylinders using a jet of liquid fluid or an air knife and transporting such removed flakes away from the supply cylinders.

The fluid may by itself prevent recombination or fusion of material by maintaining the flakes separated as discrete particles; it may prevent, delay or reduce corrosion (e.g., oxidation) of flakes; and/or the fluid may counteract any deleterious effect that may be associated with flake production, including in an environment devoid of liquid fluid, such as flakes detonation and/or combustion.

The fluid may be supplemented with any desirable agent, such as an anti-oxidant to further reduce, delay, or prevent flake oxidation and may include an additive to modify the flake, and be for instance a doping agent. The interested reader is referred to simultaneously filed PCT application No. PCT/IB2021/052743 titled “Method For Making Flakes” (Agent Ref. LIP 16/007 PCT) for an explanation in greater detail of the manner in which additives may enhance the present method and apparatus. This application is incorporated herein by reference for all purposes as if fully set forth herein.

While the fluid may be continually replenished, it is preferred for it to be recycled after it has been passed through a filter to separate out the desired flakes. The filter may be designed to remove all the particles from the fluid before it is recycled but it in some embodiments only a proportion, preferably a major proportion, of the particles is retained in the filter. Other means can be used to separate the particles, such as by affinity, decanting, or centrifuging, to name a few. The particles that are recycled in the fluid may assist the production of further particles and may themselves be reduced in size by the recycling.

The fluid may be liquid and include one or more liquid carriers, and optionally one or more additives and/or solid particles (e.g., flakes). A fluid may comprise or primarily comprise any of the following carriers: water (e.g., if the material of the supply cylinder is compatible with water); an alcohol, including primary, secondary and tertiary, monohydric and polyhydric alcohols; a glycol ether; a hydrocarbon; an organosilicon oil; and mixtures thereof, the foregoing list not being exhaustive. For instance, a liquid fluid may comprise an isoparaffinic hydrocarbon (e.g., as commercially provided by Exxon Mobile under Isopar™ trade name).

The fluid can alternatively be a gas (or a gas mixture), in which case it may comprise or primarily comprise air or an inert gas, such as nitrogen or argon. If a supply cylinder comprises a material whose flakes would be combustible in air and/or water (e.g., a material which comprises primarily aluminium or lithium), it may be preferable to not use air and/or water in the fluid.

If additives are present in the fluid, the apparatus may further include a dosing device to enable the preparation of a fluid supplemented with a desired amount of each additive or the replenishment of a recycled fluid, by the extent of additive depleted in previous cycles.

### Method of Flake Production

In implementing the method of production of the present disclosure, for instance in an apparatus as illustrated in FIGS. 5 to 7, one commences by selecting the material, diameter, and surface texture of the fatiguing rods 234 that is suited to the material of the supply cylinders 222. After the supply cylinders and fatiguing rod(s) assemblies have been correctly stacked, the pressure applied, for instance by the hydraulic rams, is increased and at least one motor 270 is activated. To reduce the initial torque requirement on the motor 270, its activation may be commenced before the pressure is ramped up.

Fluid is now applied to the nips as the one or more motors 270 drive all the supply cylinders and intervening fatiguing rods in rolling contact therewith. The fluid is collected and can be filtered to remove the produced flakes from the fluid. Based on analysis of the produced flakes and their rate of production, the applied pressure and speed of rotation of the motors and cylinders associated therewith may be modified to achieve desired results. For example, the speed of rotation may be increased as the supply cylinders reduce in diameter, though surprisingly this was found not to be necessary.

After the flakes have been collected, for instance by filtration of the fluid through a sieving media adapted to retain the particles of a desired size, they may be subjected to further processing. Flakes can alternatively be separated from the fluid by sedimentation, centrifugation, or any non-mechanical method suited to the materials of the flakes, as readily appreciated by persons skilled in separation of particles. Though separation of the flakes from the fluid can be done off-line and in batches, separation that can be performed in-line during the flaking process and/or in a continuous manner is deemed advantageous.

During production of flakes by the method described above, a sample supply cylinder 222 and the flakes produced therefrom were examined. The sample supply cylinder 222 was made up of Al 1100, a pure alloy comprising at least 99% aluminium. It was found that flakes on the surface of the cylinder started out thick and then, as contact with rod 234 continued, the material being “peeled” from the supply cylinder outer surface stretched and thinned out until the thinned out material broke off in flakes.

The production rate of flakes from a given supply cylinder 222, the thickness of the flakes, and/or the characteristics of the flakes were found to vary depending on, inter alia, a) the design of the cylinders 222, the rods 234 and the support cylinders 232 (when present), including inter alia the materials from which they are made, b) the existence and composition of the fluid, c) the texture (e.g., roughness or patterning) of fatiguing rods 234, d) the respective speed of any of cylinders and rods, e) the differences in cylinder speed, f) the hardness ratio between the hardness of rods 234 and supply cylinder 122, g) the number of fatiguing rods in an assembly; and h) the amount of pressure.

Accordingly, an apparatus may further comprise one or more controllers, each selected and adapted to control constantly or periodically at least one of :
a) the force or pressure applied by the compression mechanism;
b) the speed of rotation of at least one of the supply cylinders;
c) the speed of rotation of at least one of the support cylinders, if present;
d) at least one of the flow rate, the temperature, and the concentration of solid particles and/or additive(s) in the fluid applied to the supply cylinders; and
e) the fluid level in the collector.

The characteristics of the flakes that are removed from supply cylinder 122 need not necessarily be identical to the characteristics of the flakes that are collected. For example, chemical reactions may occur with one or more components of a fluid used in apparatus 100 and/or with one or more components otherwise present in the operating environment of apparatus 100. Thus, the apparatus 100 may in some embodiments be configured to further process the flakes after removal and/or collection. Such processes may include, partial or complete separating out, breaking up, annealing, changing of the fluid (if present) and/or addition of a fluid, coating (e.g., with silica), and/or any other appropriate processing. Such further processing optionally affects one or more characteristics of the flakes (e.g., breaking up a flake may reduce the planar dimensions of the flake).

Flakes produced in accordance with some embodiments of the presently disclosed subject matter may be characterized by any suitable aspect ratio between their representative planar dimension and transverse dimension in a range from about and including 2:1 to about and including 10,000:1. A representative planar dimension of a flake can be its diameter, for flakes having the shape of a flattened sphere, or the longest length across the plane, for flakes having other shapes. A representative dimension of a flake transverse to its plane can be its thickness. Such dimensions and their average can be determined by routine experimentation using Dynamic Light Scattering (DLS) techniques, where the particles are approximated to spheres of equivalent scattering response and the size expressed as hydrodynamic diameter. The values observed for 50% of the population by volume (D_{V}50) or by number (D_{N}50) are often commonly referred to as D50 or the average particle size of the flake and may serve to estimate the representative planar dimension of the flakes. Dimensions of particles may also be estimated by microscopic methods and analysis of images captured by scanning electron microscope (SEM), transmission electron microscope (TEM), focused ion beam (FIB), and/or by confocal laser scanning microscopy techniques. While microscopic methods can be used to determine all dimensions of the flakes, they are typically used to assess their thickness.

Flakes prepared using an apparatus according to any of the present teachings can have a) an average representative planar dimension (e.g., longest length or D50) of at least 50 nm, at least 250 nm, or at least 1 µm; and/or b) an average representative dimension transverse to the plane (e.g., thickness) of at least 10 nm, at least 20 nm, or at least 30 nm; and/or c) an average aspect ratio of a least about 3:1, at least 5:1, at least 10:1, at least 50:1, at least 100:1, or at least 1,000:1. In some embodiments, the flakes have a) an average planar dimension of at most 200 µm, at most 150 µm, or at most 75 µm; and/or b) an average transverse dimension of at most 20 µm, at most 5 µm, at most 2 µm, or at most 1 µm; and/or c) have an aspect ratio of at most 10,000:1, at most 5,000:1, or at most 2,000:1. Such ranges encompass the dimensions of the flakes upon their detachment of a supply cylinder, upon their collection and separation. The dimensions of the flakes and their aspect ratio may depend inter alia on the operating conditions of the apparatus and the composition, relative hardnesses, relative diameters, and pressures perceived/applied by the respective cylinders and rods. The apparatus may therefore be used to produce flakes having desired dimensions.

The inventors have carried out several experiments to assess the effect of varying the various parameters mentioned above. Some combinations, as tested in apparatuses as depicted in FIGS. 3 or 5, are summarized in Table 1, but the detailed conditions of each experiment are not repeated herein, as they are described in GB 2593768 which is incorporated herein by reference. The interested reader is also referred to GB 2593768 for an explanation in greater detail of the manner in which the various supply cylinders, support cylinders and fatiguing rods may be supported by the exemplified support structures and journaled, as well as providing more information on suitable values of the different parameters that affect the production of flakes, using supply cylinders of various materials and size. All experiments led to the production of flakes within the ranges as herein described.

In the table, the diameters of the cylinders or fatiguing rods are provided in millimeters (mm) and refer in the case of the supply cylinders to the initial diameter at the beginning of the experiment. If an otherwise similar assembly was tested with different diameters of cylinders or texturing of the fatiguing rod roughness thereof (e.g., roughness (provided in nm), coating and/or patterning of the reaction rod (provided in µm), all such values are listed in the cells of relevance. For brevity, NC means that a fatiguing rod is not coated, whereas NP means that a fatiguing rod is not patterned. If a rod is patterned, the relevant cells shall list the parameters of the pattern. Hence, a single line (item No.) in the below table may refer to a number of distinct experiments. Such experiments were carried out with the following fluids: air, water, butanol, ethanol, isopropanol, chloroform, hexamethyldisiloxane, propylene glycol methyl ether, Isopar™ E, Isopar™ L, Isopar™ M, Marcol® 82, and combinations thereof, the liquid fluids being optionally supplemented with additives. All experiments were performed at a velocity of at least 70 rpm for the supply cylinders, under a pressure of at least 500 kg on supply cylinders having a length of at least 190 mm and a diameter of at least 100 mm.

TABLE 1

| No. | Supply cylinder (Ø) | Fatiguing rod (Ø / Ra / coating / patterning) | Support cylinder (Ø) |
|---|---|---|---|
| 1 | Al 1050 (285) | WC (Ø 10, 15, 20, 25 / Ra 500 / NC / NP) | SST 17-4 PH (300) |
| 2 | Al 1100 (100) | WC (Ø 5 / Ra 200 / NC / NP) | H13 Tool Steel (100) |
| 3 | A1 1100 (100) | WC or SST 17-4 PH (Ø 1, 2, 3, 5 / Ra 100 / NC / NP) | SST 17-4 PH (100) |
| 4 | A1 1100 (100) | WC (Ø 5, 15 / Ra 100 / NC / NP) | SST 17-4 PH (100) |
| 5 | A1 1100 (100) | WC (Ø 5 / Ra 100 / NC / NP) | SST 17-4 PH (100) |
| 6 | A1 1100 (100) | WC (Ø 5 / Ra 20, 100, 250, 500 / NC / NP) | SST 17-4 PH (100) |
| 7 | A1 1100 (100) | WC (Ø 5 / Ra 20 / NC / NP) | SST 17-4 PH (100) |
| 8 | A1 1100 (65) | SST 17-4 PH (65) or A1 1100 (65) / NC / NP | None |
| 9 | A1 1100 (100) | WC (Ø 5, 10 / Ra 20, 100, 500 / coated TiAlN or AlTiSiCrN) / NP | SST 17-4 PH (100) |
| 10 | A1 1100 (100) | SiC (Ø 5/ Ra 100/ NC / NP) | SST 17-4 PH (100) |
| 11 | A1 1100 (100) | SST 17-4 PH (Ø 5/ Ra 800 / NC / NP) | SST 17-4 PH (100) |
| 12 | A1 1100 (100) | A1 6061 (Ø 15/ Ra 800 / NC / NP) | SST 17-4 PH (100) |
| 13 | A1 1100 (120) | WC (Ø 10 / Ra 400, 500, 700 / NC / NP) | SST 17-4 PH (100, 155) |
| 14 | A1 1100 (120) | WC (Ø 10 / Ra 500 / NC / NP) With positive, negative or no skid | SST 17-4 PH (155) |
| 15 | A1 1100 (125) | WC (Ø 10 / Ra 500 / NC / NP) Pair of attrition rods per assembly | SST 17-4 PH (300) |
| 16 | A1 1100 (110) | SST 17-4 PH (Ø 10 / Ra 400, 2000, 5000 / diamonds coated / NP) | SST 17-4 PH (155) |
| 17 | A1 1100 (125) | SST 17-4 PH (Ø 15, 25 / Ra 2000 / diamonds coated / NP) | SST 17-4 PH (155) |
| 18 | A1 1100 (125) | WC (Ø 10 / Ra 60 / NC / Patterned at G 50, 60, 150, 200; T 25, 50, 200; D 10, 35; α° 0, 2, 30, 40) | SST 17-4 PH (300) |
| 19 | A1 1100 (125) | SST (Ø 25 / Ra 200 / NC / Patterned at G 160, 230, 280, 430, 650; T 130, 160, 240, 360; D 90, 160, 170, 190, 400; α° 2) | SST 17-4 PH (300) |
| 20 | A1 1199 (100) | WC (Ø 5, 15 / Ra 20, 100 / NC / NP) | SST 17-4 PH (100) |
| 21 | A1 2024 (100) | WC (Ø 1, 2, 3, 5 / Ra 100 / NC / NP) | SST 17-4 PH (100) |
| 22 | A1 6061 (100) | WC (Ø 1, 3, 5 / Ra 100 / NC / NP) | SST 17-4 PH (100) |
| 23 | A1 6061 (100) | A1 6061 (Ø 10 / NC / NP) | SST 17-4 PH (100) |
| 24 | A1 6061 (285) | WC (Ø 10 / Ra 500 / NC / NP) | None |
| 25 | A1 6061 (285) | WC (Ø 15, 25 / Ra 500 / NC / NP) | SST 17-4 PH (300) |
| | | Pair of attrition rods per assembly | |
| 26 | A1 6061 (285) | WC (Ø 10 / Ra 60 / NC / Patterned at G 50, 60, 150, 200; T 25, 50, 200; D 10, 35; α° 0, 2, 30, 40) | SST 17-4 PH (300) |
| 27 | A1 6061 (285) | SST (Ø 25 / Ra 200 / NC / Patterned at G 160, 230, 280, 430, 650; T 130, 160, 240, 360; D 90, 160, 170, 190, 400; α° 2) | SST 17-4 PH (300) |
| 28 | A1 7075 (100) | WC (Ø 1, 5, 10 / Ra 100, 500 / NC / NP) | SST 17-4 PH (100, 155) |
| 29 | A1 A356 (130) | WC (Ø 10 / Ra 200 / NC / NP) | SST 17-4 PH (155) |
| 30 | A1 A4047 (100) | WC (Ø 10 / Ra 200 / NC / NP) | SST 17-4 PH (155) |
| 31 | A1 RSP (120) | WC (Ø 10 / Ra 200 / NC / NP) | SST 17-4 PH (155) |
| 32 | Brass [Cu:Zn 80:20] (100) | WC (Ø 10 / Ra 200, 500 / NC / NP) | SST 17-4 PH (155) |
| 33 | Bronze SAE 65 (100) | WC (Ø 10 / Ra 200 / NC / NP) | SST 17-4 PH (155) |
| 34 | Copper (100) | WC (Ø 10 / Ra 400 / NC / NP) | SST 17-4 PH (155) |
| 35 | PMMA (100) | WC (Ø 10 / Ra 250 / NC / NP) | SST 17-4 PH (100) |
| 36 | SST 304 (100) | WC (Ø 5 / Ra 100 / NC / NP) | SST 17-4 PH (100) |
| 37 | Tin (100) | WC (Ø 5 / Ra 200 / NC / NP) | SST 17-4 PH (100) |
| 38 | Zinc (100) | WC (Ø 10 / Ra 200, 500 / NC / NP) | SST 17-4 PH (155) |

While, for the sake of illustration, this disclosure has been described in terms of certain embodiments and generally associated methods, alterations and permutations of the embodiments and methods will be apparent to those skilled in the art based upon Applicant’s disclosure herein. The present disclosure is to be understood as not limited by the specific embodiments described herein. It is intended to embrace all such alternatives, modifications and variations and to be bound only by the spirit and scope of the disclosure and any change which come within their meaning and range of equivalency.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Unless otherwise stated, the use of the expression “and/or” between the last two members of a list of options for selection indicates that a selection of one or more of the listed options is appropriate and may be made.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

In the disclosure, unless otherwise stated, adjectives such as “substantially”, “approximately” and “about” that modify a condition or relationship characteristic of a feature or features of an embodiment of the present technology, are to be understood to mean that the condition or characteristic is defined to within tolerances that are acceptable for operation of the embodiment for an application for which it is intended, or within variations expected from the measurement being performed and/or from the measuring instrument being used. When the terms “about” and “approximately” precede a numerical value, it is intended to indicate +/-15%, or +/-10%, or even only +/-5%, and in some instances the precise value. Furthermore, unless otherwise stated, the terms (e.g., numbers) used in this disclosure, even without such adjectives, should be construed as having tolerances which may depart from the precise meaning of the relevant term but would enable the invention or the relevant portion thereof to operate and function as described, and as understood by a person skilled in the art.

In the description and claims of the present disclosure, each of the verbs “comprise”, “include” and “have”, and conjugates thereof, are used to indicate that the object or objects of the verb are not necessarily a complete listing of features, members, steps, components, elements or parts of the subject or subjects of the verb.

As used herein, the singular form “a”, “an” and “the” include plural references and mean “at least one” or “one or more” unless the context clearly dictates otherwise. At least one of A and B is intended to mean either A or B, and may mean, in some embodiments, A and B.

Positional or motional terms such as “upper”, “lower”, “right”, “left”, “bottom”, “below”, “lowered”, “low”, “top”, “above”, “elevated”, “high”, “vertical”, “horizontal”, “backward”, “forward”, “upstream” and “downstream”, as well as grammatical variations thereof, may be used herein for exemplary purposes only, to illustrate the relative positioning, placement or displacement of certain components, to indicate a first and a second component in present illustrations or to do both. Such terms do not necessarily indicate that, for example, a “bottom” component is below a “top” component, as such directions, components or both may be flipped, rotated, moved in space, placed in a diagonal orientation or position, placed horizontally or vertically, or similarly modified.

Unless otherwise stated, when the outer bounds of a range with respect to a feature of an embodiment of the present technology are noted in the disclosure, it should be understood that in the embodiment, the possible values of the feature may include the noted outer bounds as well as values in between the noted outer bounds.

To the extent necessary to understand or complete the disclosure of the present disclosure, all publications, patents, and patent applications mentioned herein, including in particular the applications of the Applicant, are expressly incorporated by reference in their entirety by reference as is fully set forth herein.

1. An apparatus for producing flakes, comprising:
a. a support structure for supporting each of two supply cylinders, made of a first material from which flakes are to be produced, and a fatiguing rod assembly including at least one fatiguing rod made of a second material, each fatiguing rod having a diameter smaller than an initial diameter of the two supply cylinders;
b. a compression mechanism for urging the surfaces of the two supply cylinders into contact with each fatiguing rod; and
c. a drive mechanism for causing the supply cylinders to rotate while making rolling line contact with each fatiguing rod;
wherein the contact pressure between the supply cylinders and each fatiguing rod is sufficiently high to modify the surface of the supply cylinders by fatigue and result in separation of flakes of the first material from the surfaces of the supply cylinders.

2. An apparatus as claimed in claim 1, further comprising:
a mechanism for supplying a fluid to each fatiguing rod and supply cylinder during rotation thereof, the fluid being operative to carry away flakes produced by the fatiguing of the supply cylinders, and
a collector to collect the produced flakes and the fluid.

3. An apparatus as claimed in claim 2, wherein the apparatus further comprises a separating system for separating at least a proportion of the flakes from the fluid.

4. An apparatus as claimed in claim 2, wherein the fluid is a liquid and the apparatus further comprises a recycling mechanism for recirculating liquid from the collector or from the separating system to at least part of each line of contact.

5. An apparatus as claimed in claim 3, wherein the separating system is a filtering system.

6. An apparatus as claimed in claim 1, wherein at least one fatiguing rod has an average surface roughness (Ra) greater than 0.2 µm, greater than 1 µm, greater than 2 µm, or greater than 3 µm.

7. An apparatus as claimed in claim 1, wherein at least one fatiguing rod is coated with a layer, or with particles, of a third material different from the first and the second material.

8. An apparatus as claimed in claim 1, wherein the texture of at least one fatiguing rod or a segment thereof is random; or follows a repeating pattern of continuous or interrupted protrusions.

9-12. (canceled)

13. An apparatus as claimed in claim 1, wherein the drive mechanism comprises one or more motors, each optionally associated with a respective supply cylinder.

14. An apparatus as claimed in claim 13, wherein the one or more motors are movably supported to accommodate relative movement between the axes of the respective supply cylinders as the outer diameters of supply cylinders reduce during operation.

15. An apparatus as claimed in claim 1, wherein a support cylinder is provided for contacting a supply cylinder that is in contact with a fatiguing rod assembly on only one side, the compression mechanism serving to urge the support cylinder against the opposite side of the supply cylinder.

16. An apparatus as claimed in claim 15, wherein the support cylinder is made of a fourth material harder than the first material.

17. An apparatus as claimed in claim 1, wherein the supply cylinder is constituted of a support shaft and a supply sleeve, the support shaft being journaled in a pair of bearings slidably mounted in the support structure.

18. An apparatus as claimed in claim 1, wherein the supply cylinder is constituted of a cylinder having a central recess in its end faces, the recess serving to maintain the cylinder between a pair of tailstocks, each slidably mounted on a side of the support structure.

19. An apparatus as claimed in claim 1, wherein the fatiguing rod assembly includes two fatiguing rods at least one of the fatiguing rods being made of the second material, the outer surfaces of the two fatiguing rods being same or different.

20. An apparatus as claimed in claim 1, wherein (a) each fatiguing rod assembly includes one fatiguing rod and the outer surfaces of the fatiguing rods of two rod assemblies on either side of a common supply cylinder differ from one another, or b) each fatiguing rod assembly includes two fatiguing rods the outer surfaces of which differ from one another.

21. An apparatus as claimed in claim 1, wherein at least one fatiguing rod is configured to oscillate is a direction parallel to the axis of rotation of the fatiguing rod.

22. An apparatus as claimed in claim 4, further comprising a controller serving to control constantly or periodically at least one of:
a) the force or pressure applied by the compression mechanism;
b) the speed of rotation of at least one of the supply cylinders;
c) the speed of rotation of at least one of the support cylinders, if present;
d) at least one of the flow rate, the temperature, and the concentration of solid particles and/or additive(s) in the fluid applied to the supply cylinders; and
e) the fluid level in the collector.

23. A method of producing flakes, which comprises:
a. supporting two supply cylinders and a fatiguing rod assembly, that includes at least one fatiguing rod, in such a manner that each fatiguing rod is sandwiched between the two supply cylinders, each fatiguing rod having a diameter smaller than an initial diameter of the two supply cylinders and being made of a harder material;
b. urging the surfaces of the two supply cylinders into contact with each fatiguing rod; and
c. causing the supply cylinders and the fatiguing rods to rotate while making rolling line contact with one another;
wherein the supply cylinders and each fatiguing rod are urged against one another with sufficiently high contact pressure to modify the surface of the supply cylinders by fatigue and result in separation of flakes of the first material from the surfaces of the supply cylinders.

24. (canceled)

25. Aluminium flakes produced by a method which comprises:
a. supporting two supply cylinders and a fatiguing rod assembly, that includes at least one fatiguing rod, in such a manner that each fatiguing rod is sandwiched between the two supply cylinders, each fatiguing rod having a diameter smaller than an initial diameter of the two supply cylinders and being made of a harder material;
b. urging the surfaces of the two supply cylinders into contact with each fatiguing rod; and
c. causing the supply cylinders and the fatiguing rods to rotate while making rolling line contact with one another;
wherein the supply cylinders and each fatiguing rod are urged against one another with sufficiently high contact pressure to modify the surface of the supply cylinders by fatigue and result in separation of flakes of the first material from the surfaces of the supply cylinders.
